(19) United States
(12) Patent Application Publication
(10) Pub. No.: US 2026/0014592 A1
(43) Pub. Date: Jan. 15, 2026

(54) SYSTEM AND METHOD FOR SORTING OUT DIFFERENT TYPES OF MATERIAL FROM A WASTESTREAM, AND SYSTEM FOR PURIFYING OF A STREAM OF A FILM PLASTIC MATERIAL FRACTION

(71) Applicant: TOMRA SORTING GMBH, Mülheim-Kärlich (DE)

(72) Inventors: Hans Jürgen Priesters, Schleiden (DE); Lisa Maria Höflechner, Köln (DE); Hildemar Mendez Guillen, Ravensburg (DE)

(21) Appl. No.: 18/881,925

(22) PCT Filed: Jul. 13, 2022
(86) PCT No.: PCT/EP2022/069547

§ 371 Date: Jan. 7, 2025

(51) Int. Cl. B07C 5/342; B07C 5/02; B29B 17/02

(52) U.S. Cl. CPC B07C 5/342; B07C 5/02; B29B 17/02; B07C 2501/0054; B29B 2017/0279

(57) ABSTRACT

The present disclosure relates to a system for sorting out different types of material from a waste stream such as a municipal solid waste, MSW, stream (MS). The system comprises a pre-sorting arrangement, a first classification and sorting arrangement, and a second classification and sorting arrangement. A system for purifying of a stream of a film plastic material fraction sorted out by the system for sorting out different types of material from a municipal solid waste stream is also disclosed. The system comprises a first purifying classification and sorting arrangement. A method for sorting out different types of material from a waste stream such as a municipal solid waste, MSW, stream (MS) is further disclosed.

### FIELD OF INVENTION

The present invention relates to a system for sorting out different types of material from a waste stream, such as a municipal waste (MSW) stream and to a system for purifying of a stream of a sorted film plastic material fraction. The present invention also relates to a method for sorting out different types of material from the waste stream.

### TECHNICAL BACKGROUND

Plastic material is an important resource for the industry, both in produced products as well as for protecting the products during transport. Plastic materials have many advantageous properties e.g. it is a light material making it good for packaging and also more environmental friendly transports. Plastic materials are also advantageous since it resists water and many chemicals which leads to a low wear and result in a long lifetime for many types of plastic materials. The characteristics of plastic materials that gives it the long lifetime are not only an advantage, since it causes problems in material handling, especially from a recycling perspective. When plastic materials end up in the nature its long degradation time causes eco unfriendly processes for decomposing the plastic materials which leads to problems for the plant and wildlife.

The combination of the advantages and the disadvantages of plastic materials makes it a product that is needed in the industry but after use the plastic materials needs to be collected and taken care of as waste. Incineration, landfilling and recycling, both chemical and mechanical, are currently the main techniques used to manage the plastic waste. However, there are many problems associated with managing plastic waste. One problem is that it takes a large amount of energy to incinerate plastic waste and the incineration process produces many products that are harmful to humans and the environment such as carbon monoxide, carbon dioxide, chlorine, and other hydrocarbons. These gases also contribute to the problem with global warming. A problem with discarding plastics waste in landfills is that it takes up landfill space and that it is labour intensive. Moreover, waste-to-energy conversion is not efficient when discarding plastics waste.

Therefore, recycling is a good way to take care of plastic waste. It is known that most types of plastic waste can be recycled through a mechanical process or a chemical process. When the plastic waste is recycled through a mechanical process the quality of the plastic material decreases for each time it is recycled. Chemical recycling makes it possible to convert the plastic material back into molecules which generally enhances the level of quality of the recycled plastic material.

One important aspect when recycling plastic material is the grade of purity of the fraction of recovered plastic material. If the level of purity is low in the plastic waste stream, the quality of the recycled plastic material decreases which result in that the value of the recovered plastic material also decreasing. Hence, one deciding factor in the recycling of plastic materials are the purity level of the recovered recycled plastic material.

The accuracy of the associated sorting process is thus imperative to ensure of that the different types of plastic materials are recovered with the highest possible purity.

Municipal solid waste, MSW, is a source of plastic waste. MSW is typically collected via a bin system where people living in an area throws their waste in bins. The MSW is then often transported to a recycling plant. To be able to recycle the plastic waste it needs to be sorted out from the rest of the MSW.

Many processes are known for handling MSW streams. For example, US20030019795 discloses a waste to resource process that eliminates the need for disposing usable materials into large landfills or in a bioreactor or an incinerator. U.S. Pat. No. 7,802,685 discloses a multistep recycling process for preparing recycled plastic materials.

However, it may be noted that the existing handling processes of MSW streams are not satisfactory in terms of the level of recovered plastic material and in that the purity level of the sorted and recovered plastic material fractions are too low. The existing processes are also too labour intensive and the plant is not flexible enough to be adapted to different sorting needs depending on the area the plant is located in. There is a need of waste recycling plants that are able to recycle higher volumes of plastic waste streams, with increased accuracy and higher purity levels to ensure an overall recycling process which is both effective and efficient in recovering plastic material fractions with increased profit margins.

### SUMMARY OF INVENTION

In view of the above, it is an object of the present invention is to provide an improved system for recovering or sorting out different types of materials from a waste stream, such waste stream typically being a municipal solid waste, MSW, stream.

It is also an object of the present invention to provide a system for purifying of a waste stream to recover or sort out from a waste stream, such as from a municipal solid waste, MSW, stream, a film plastic material fraction as at least one fraction recovered or sorted by the system.

It is also an object of the present invention to provide an improved method for recovering or sorting out different types of materials from a waste stream such as a municipal solid waste, MSW, stream.

It is also an object to provide a solution that addresses at least some of the criteria described above, namely, to provide a waste stream, such as a MSW stream handling system with an improved level of recycling.

Another object is to provide a solution that can recover or sort the different waste fractions with a higher precision creating a higher purity level of the desired plastic material fractions. Preferably the system is easy to adapt and scale depending on the different needs of each recycling plant.

A further object is to provide a system that are able to sort out a number of different plastic materials from each other into separate fractions.

It is also an object to provide a cost-effective system for recovering and sorting out different types of material from a waste stream such as a municipal solid waste, MSW, stream.

It is also an object to provide a cost-effective method for recovering and sorting out different types of material from a waste stream such as a municipal solid waste, MSW, stream.

To achieve at least one of the above objects, and also other objects that will be evident from the following description, a system having the features defined in claim 1 is provided according to the present invention. Preferred variants of the system will be evident from the dependent claims.

More specifically, there is provided according to a first aspect a system for sorting out different types of material from a waste, stream. The system comprising; a pre-sorting arrangement, a first classification and sorting arrangement, and a second classification and sorting arrangement, wherein the pre-sorting arrangement comprising, a separator unit configured to separate plastic materials from the waste stream into a particulate stream of plastic material and a film stream of plastic material based on a combination of size, shape and density such that particulate plastic material is predominantly separated into the particulate stream of plastic material while plastic film material is predominantly separated into the film stream of plastic material, wherein the first classification and sorting arrangement comprising, a first particulate classification and sorting station configured to receive the particulate stream of plastic material from the pre-sorting arrangement, the first particulate classification and sorting station comprising a near infrared, NIR, spectroscopy system configured to discriminate a first type of particulate plastic from other types of particulate plastics in the particulate stream of plastic material, and an ejection unit configured to divert the first type of particulate plastic from the particulate stream of plastic material into a first particulate plastic material fraction, thereby sorting out material of the first type of particulate plastic from the particulate stream of plastic material, wherein the first classification and sorting arrangement further comprising, a second particulate classification and sorting station configured to receive the particulate stream of plastic material from the first particulate classification and sorting station, the second particulate classification and sorting station comprising a near infrared, NIR, spectroscopy system configured to discriminate a second type of particulate plastic from other types of particulate plastics in the particulate stream of plastic material received by the second particulate classification and sorting station from the first particulate classification and sorting station, and an ejection unit configured to divert the second type of particulate plastic from the particulate stream of plastic material into a second particulate plastic material fraction, thereby sorting out material of the second type of particulate plastic from the particulate stream of plastic material received by the second particulate classification and sorting station, wherein the second classification and sorting arrangement comprising, a first film classification and sorting station configured to receive the film stream of plastic material from the pre-sorting arrangement, the first film classification and sorting station comprising a near infrared, NIR, spectroscopy system configured to discriminate a first type of film plastic from other types of film plastics in the film stream of plastic material, and an ejection unit configured to divert the first type of film plastic from the film stream of plastic material into a first film plastic material fraction, thereby sorting out material of the first type of film plastic from the film stream of plastic material, wherein the second classification and sorting arrangement further comprising a second film classification and sorting station configured to receive the film stream of plastic material from the first film classification and sorting station, the second film classification and sorting station comprising a near infrared, NIR, spectroscopy system configured to discriminate a second type of film plastic from other types of film plastics in the film stream of plastic material received by the second film classification and sorting station from the first film classification and sorting station, and an ejection unit configured to divert the second type of film plastic from the film stream of plastic material into a second film plastic material fraction, thereby sorting out material of the second type of film plastic from the film stream of plastic material received by the second film classification and sorting station.

The pre-sorting arrangement of the system performs a first sorting of the plastic material into a particulate stream of plastic material and a film stream of plastic material. The sorting is based on the size, shape and density of the plastic material.

The film plastics are plastic which are generally thin. Such film plastic material may as an example be used to act as barriers for items and food. One example of a film plastic may be plastic wrap.

The particulate plastic is generally more rigid. The particulate plastic is generally thicker than the film plastic. Particulate plastic may as an example be used for containers. One example of a particulate plastic may be a bottle.

By separating the film plastic and the particulate plastic into two different streams the sorting process in the upcoming stages of the system are improved.

The system comprises a first classification and sorting arrangement, and
a second classification and sorting arrangement.

Hence owing from the separation performed by the pre-sorting arrangement, the two classification and sorting arrangements, i.e. the first classification and sorting arrangement, and a second classification and sorting arrangement, only need to handle one stream of plastic which reduces the risk that the classification and sorting stations misses any part or type of the plastic fraction which it is assigned to discriminate. The classification and sorting stations provide the possibility to provide settings to the NIR spectroscopy system which discriminate plastic that should be sorted out. By providing settings to the NIR spectroscopy system the system is able to discriminate selected plastic material and sort it into a selective fraction. The actual sorting is performed by ejection units configured to divert plastic based on the discrimination conducted by the NIR spectroscopy systems. The ejection units are informed by the NIR spectroscopy systems which plastic pieces that should be diverted. Then the ejection unit typically divert the plastic pieces with air jets that blows the selected plastic pieces onto one conveyor belt and the other plastic pieces will end on another conveyor belt. Alternatively or additionally, some kind of mechanical sorting or sorting with air jets may be used to advantage. The ejection unit may divert the selected plastic pieces and the other plastic pieces onto different conveyor belts. By adjusting the settings of which plastic that is discriminated into fractions the system may be customized to fit different needs of the location and the country where it is located. Thus, the system may be easy to adapt to the different needs of each recycling plant.

When the waste stream is separated into two different streams, i.e., the particulate stream of plastic material and the film stream of plastic material, by the pre-sorting arrangement the classification and sorting arrangements may be able to sort the plastic into fractions with a higher purity than if all the plastic were sorted directly from the waste stream. When the purity of such fractions is higher the plastic may in turn be recycled to products with higher quality. Thus, the system provides a final product with a higher value which may yield a higher price on the aftermarket. With a higher value more plastic will typically be recycled hence decreasing the amount of waste that end up at land dumps or in incineration facilities. The system provides an improved overall sorting by combining the different stations in such way that the plastic will be well sorted when it arrives to the different classification and sorting arrangements. Each station would not be able to reach as good results individually as when they are combined. The total purity of the recycled fractions will be significantly higher with this specific combination, due to the synergies between the stations.

The first classification and sorting arrangement may further comprise a further particulate classification and sorting station configured to receive the particulate stream of plastic material from the second particulate classification and sorting station, the further particulate classification and sorting station may comprise a near infrared, NIR, spectroscopy system configured to discriminate a further type of particulate plastic from other types of particulate plastics in the particulate stream of plastic material received by the further particulate classification and sorting station from the second particulate classification and sorting station, and an ejection unit configured to divert the further type of particulate plastic from the particulate stream of plastic material into a further particulate plastic material fraction, thereby sorting out material of the further type of particulate plastic from the particulate stream of plastic material received by the further particulate classification and sorting station.

The system may include one or more further particulate classification and sorting stations. The number of further particulate classification and sorting stations are typically determined by the number of particulate plastic fractions that are of interest for recycling in the particulate stream of plastic material. Such further particulate classification and sorting station typically discriminate a further type of particulate plastic from other types of particulate plastics in the particulate stream of plastic material received by the further particulate classification and sorting station from the second particulate classification and sorting station. The number of further particulate classification and sorting stations further increase the possibility to adapt the system to the conditions of the country where the plant is installed. With a further particulate classification and sorting station it is possible to recycle further types of plastic materials. By recycling further types of plastic material, the quantity of waste that ends up not recycled will be further decreased.

The first classification and sorting arrangement may further comprise, a cleaning particulate classification and sorting station, for one or more particulate plastic material fractions, each cleaning particulate classification and sorting station may be configured to receive a respective particulate plastic material fraction from a respective particulate classification and sorting station, each cleaning particulate classification and sorting station may comprise a NIR spectroscopy system configured to discriminate the type of particulate plastic of the particulate plastic material fraction from other types of particulate plastics in the received particulate plastic material fraction, and an ejection unit configured to divert the other types of particulate plastic from the particulate material fraction into a joint residue particulate stream such that the particulate plastic material fraction is further cleaned from other types of particulate plastics.

The cleaning particulate classification and sorting station may be the same type of station as the classification and sorting station. The cleaning particulate classification and sorting station may discriminate materials with different spectra than the particulate plastic material fraction such that any material that may have ended up in the wrong fraction will be diverted into the joint residue particulate stream. The joint residue particulate stream is thus typically a collection stream of material that ended up in the wrong fraction.

There may be one or more cleaning particulate classification and sorting stations in the classification and sorting arrangement. Each cleaning particulate classification and sorting station may be situated downstream of one of the particulate classification and sorting stations. The cleaning particulate classification and sorting station may therefore handle the particulate plastic material fraction from the particulate classification and sorting station upstream. There may be one cleaning particulate classification and sorting station after each particulate classification and sorting station such that the first particulate classification and sorting station has a first cleaning particulate classification and sorting station and that the second particulate classification and sorting station has a second cleaning particulate classification and sorting station. Any further particulate classification and sorting station may have a further cleaning particulate classification and sorting station.

One cleaning particulate classification and sorting station may handle the fractions from two or more of the particulate classification and sorting stations. The cleaning particulate classification and sorting station may use different settings for the spectroscopy system on different longitudinal sides or portions of a conveyor belt of the particulate classification and sorting station. In this case, both longitudinal sides or portions are located on a top side of conveyor belt, i.e., on a side which is opposite to the force of gravity. Hence the objects on the different longitudinal sides will travel side by side on the conveyor belt. This means that the spectroscopy system may use one setting to discriminate one type of plastic material on one longitudinal side of a conveyor belt and a different setting to discriminate a second type of plastic material on the other longitudinal side of the conveyor belt. The cleaning particulate classification and sorting station may further improve the purity of the recycled plastic fraction. With a higher purity of the recycled plastic the quality of the recycled plastic will increase. Therefore, the plastic can be used in an increased number of life cycles.

Each particulate plastic material fraction may be one of PET originating from bottles, PET originating from trays, Polypropylene, Polyethylene, Polystyrene, Expanded Polystyrene, Polyurethane, Polyvinyl chloride, Polycarbonate, Polymethyl acrylate and Polyamide.

The NIR spectroscopy system may sort each type of plastic material according to provided settings into a fraction. There may however be further plastic materials that are worth sorting out.

The first classification and sorting arrangement may further comprise a recovery particulate classification and sorting station configured to receive the particulate stream of plastic material from the second particulate classification and sorting station, or if present the further particulate classification and sorting station, the recovery particulate classification and sorting station comprising a NIR spectroscopy system configured to discriminate particulate plastic from other types of materials in the particulate stream of plastic material, and an ejection unit configured to divert the particulate plastic from the particulate stream of plastic material into a recovery particulate stream of plastic material, wherein the recovery particulate stream of plastic material is re-joined with the particulate stream of plastic material from the pre-sorting arrangement.

When the plastic material is sorted out to different fractions in the particulate classification and sorting stations there may be a stacking of the plastic material on a conveyor belt used to convey the plastic material being sorted. If the particulate classification and sorting stations are not able to determinate all the plastic material some of the plastic material may not be diverted correctly or may not be diverted at all to its respective fraction. The recovery particulate classification and sorting station provides a second opportunity for the plastic material to be sorted. The recovery particulate classification and sorting station may thus discriminate and divert the plastic material, that should be sorted into its respective fraction, into a recovery particulate stream of plastic material. The recovery particulate stream of plastic material may then be re-joined with the particulate stream of plastic material such that the plastic material will be recirculated into the particulate stream of plastic material. Such recirculation of plastic material may result in even higher recycling levels of plastic.

The recovery particulate classification and sorting station may be further configured to receive the joint residue particulate stream and to discriminate particulate plastic from other types of materials in the joint residue particulate stream, and wherein the ejection unit may be further configured to divert the particulate plastic from the joint residue particulate stream of plastic material into the recovery particulate stream of plastic material.

With the recovery particulate classification and sorting station is configured to receive the joint residue particulate stream the recycling level may be further improved.

The second classification and sorting arrangement may further comprise a further film classification and sorting station configured to receive the film stream of plastic material from the second film classification and sorting station, the further film classification and sorting station may comprise a near infrared, NIR, spectroscopy system configured to discriminate a further type of film plastic from other types of film plastics in the film stream of plastic material received by the further film classification and sorting station from the second film classification and sorting station, and an ejection unit configured to divert the further type of film plastic from the film stream of plastic material into a further film plastic material fraction, thereby sorting out material of the further type of film plastic from the film stream of plastic material received by the further film classification and sorting station.

The system may include one or more further film classification and sorting stations. The number of further film classification and sorting stations are typically determined by the number of film plastic fractions that are of interest for recycling in the film stream of plastic material. Such further film classification and sorting station typically discriminate a further type of film plastic from other types of film plastics in the film stream of plastic material received by the further film classification and sorting station from the second film classification and sorting station. The number of further film classification and sorting stations further increase the possibility to adapt the system to the conditions of the country where the plant is installed. With a further film classification and sorting station it is possible to recycle further types of plastic materials. By recycling further types of plastic material, the quantity of waste that ends up not recycled will be further decreased.

The second classification and sorting arrangement may further comprise a cleaning film classification and sorting station, for one or more film plastic material fractions, each cleaning film classification and sorting station may be configured to receive a respective film plastic material fraction from a respective film classification and sorting station, each cleaning film classification and sorting station may comprise a near infrared, NIR, spectroscopy system configured to discriminate the type of film plastic of the film plastic material fraction from other types of film plastics in the received film plastic material fraction and an ejection unit configured to divert the other types of film plastic from the film material fraction into a joint residue film stream such that the film plastic material fraction is further cleaned from other types of film plastics.

The cleaning film classification and sorting station may be the same kind of station as the classification and sorting station. The cleaning film classification and sorting station may discriminate material with different spectra than the spectra of the film plastic material fraction such that any material that may have ended up in the wrong fraction may be diverted into the joint residue film stream. The joint residue film stream is hence typically a collection stream of material that ended up in the wrong fraction.

There may be one or more cleaning film classification and sorting stations in the classification and sorting arrangement. Each cleaning film classification and sorting station is typically situated downstream of one of the film classification and sorting stations. The cleaning film classification and sorting station will therefore typically handle the film plastic material fraction from the film classification and sorting station upstream. There may be one cleaning film classification and sorting station after each film classification and sorting station such that the first film classification and sorting station has a first cleaning film classification and sorting station and that the second film classification and sorting station has a second cleaning film classification and sorting station. Any further film classification and sorting station may have a further cleaning film classification and sorting station.

One cleaning film classification and sorting station may handle the fractions from two or more of the film classification and sorting stations. The cleaning film classification and sorting station can use different settings for the spectrographic system on different longitudinal sides of the conveyor belt. This means that the spectrographic system uses one setting to discriminate one type of plastic material on one longitudinal side of the conveyor belt and one different setting to discriminate a second type of plastic material on the other longitudinal side of the conveyor belt. Both longitudinal sides are located side by side also in this case, similarly to what have been discussed above. The cleaning particulate classification and sorting station may further improve the purity of the recycled plastic fraction. With a higher purity of the recycled film plastic the quality of the recycled plastic may increase. Therefore, the film plastic may be used in an increased number of life cycles.

Each film plastic material fraction may be one of Polyolefin film, low density polyethylene and polypropylene film.

The second classification and sorting arrangement may further comprise, a recovery film classification and sorting station configured to receive the film stream of plastic material from the second film classification and sorting station, or if present from the further film classification and sorting station, the recovery film classification and sorting station comprising a near infrared, NIR, spectroscopy system configured to discriminate film plastic from other types of materials in the film stream of plastic material and an ejection unit configured to divert the film plastic from the film stream of plastic material into a recovery film stream of plastic material, wherein the recovery film stream of plastic material may be re-joined with the film stream of plastic material from the pre-sorting arrangement.

When the plastic material is sorted out to different fractions in the film classification and sorting stations there may be a stacking of the plastic material on a conveyor belt used to convey the plastic material to be sorted. If the film classification and sorting stations are not able to determinate all of the plastic material some of the plastic material may not be diverted or may not be diverted to the correct fraction. The recovery film classification and sorting station may thus provide a second opportunity for the plastic material to be sorted. The recovery film classification and sorting station may discriminate and divert the plastic material, that should be sorted into its respective fraction, into a recovery film stream of plastic material. The recovery film stream of plastic material is typically re-joined with the film stream of plastic material such that the plastic material may be recirculated into the film stream of plastic material. The recirculation of plastic material may result in even higher recycling levels of plastic.

The recovery film classification and sorting station may be further configured to receive the joint residue film stream and to discriminate film plastic from other types of materials in the joint residue film stream, and wherein the ejection unit may be further configured to divert the film plastic from the joint residue film stream of plastic material into the recovery film stream of plastic material.

With the recovery film classification and sorting station configured to receive the joint residue film stream the level of recycling may be further improved.

The second classification and sorting arrangement may further comprise, a value particulate classification and sorting station configured to receive the film stream of plastic material from the recovery film classification and sorting station, the value particulate classification and sorting station may comprise a NIR spectroscopy system configured to discriminate particulate plastic from other types of materials in the film stream of plastic material, and an ejection unit configured to divert the particulate plastic from the film stream of plastic material into the joint residue particulate stream of plastic material.

In the pre-sorting arrangement the material is typically separated into the particulate stream of plastic material and the film stream of plastic material. During the pre-sorting there may be particulate material that end up in the film stream of plastic material. The film stream of plastic material ends up as residue and to avoid that particulate plastic material end up as residue the value particulate cleaning and sorting station may divert particulate plastic material from the film stream of plastic material into the recovery particulate stream of plastic material. With the value particulate cleaning and sorting station the portion of the waste stream that is recycled may be further increased.

At least one of the classification and sorting stations may further comprise a camera configured to acquire images of plastic material originating from the waste stream and an artificial neural network configured to detect different characteristics of plastic material and wherein the ejection unit of said at least one classification and sorting station may be further configured to divert said plastic material originating from the waste stream based on the detected characteristics of plastic material.

Characteristics of plastic material may thus be determined by the artificial neural network from the, by the camera, acquired images. The characteristics may be a shape, a colour, features at the surface or anything in the visual appearance of the plastic material that may be determined and classified by the artificial neural network. The camera may provide the possibility to further sort the material into different fractions. With the help of the artificial neural network it may be possible to sort plastic of the same material composition into different fractions depending on quality and origin. As merely an example it may be an advantage to be able to sort plastic from different kinds of food packages into a fraction. As a result from this the purity of the plastic fractions may be further increased.

At least one of the classification and sorting stations may further comprise a light spectroscopy system configured to acquire a spectrum of plastic material originating from the waste stream, wherein the ejection unit of said at least one classification and sorting station may be further configured to divert said plastic material originating from the waste stream based on the acquired spectrum thereby sorting the plastic material fraction based on colour.

The light spectroscopy system may through the acquired spectrum determine the different colours of the plastic material. An advantage of determining the colours of the plastic material is that it may be sorted into different fractions. Such particulate plastic material fractions may be one of PET originating from bottles, PET originating from trays, white Polypropylene, red polypropylene, Polypropylene with mixed colours, Polyethylene nature, white Polyethylene, Polyethylene with mixed colour, white Polystyrene, Polystyrene with mixed colour, expanded Polystyrene, Polyurethane, Polyvinyl chloride, Polycarbonate, Polymethyl acrylate and Polyamide. Each film plastic material fraction may be on of coloured Polyolefin film, transparent low-density polyethylene and mixed polypropylene film. This is advantageous as it may result in further increased possibilities to sort the waste stream into different fractions which may result in a further increased purity of the fractions.

At least one of the classification and sorting stations may further comprise a laser triangulation system configured to determine height information of plastic material originating from the waste stream wherein the ejection unit of said at least one classification and sorting station may be further configured to divert said plastic material originating from the waste stream based on the determined height information.

With the laser triangulation system the classification and sorting station may be able to detect plastic material that the NIR system have difficulties to detect. One example of such plastic material is black plastic material. By detecting height differences on a conveyor belt used to convey the material being sorted the classification and sorting station may combine such height information with the acquired information from the NIR system to determine if there is any black plastic on the conveyor belt. Accordingly further plastic material may be recycled.

The separator unit may comprise a wind sifter and/or a ballistic separator configured to separate the waste stream into the particulate stream of plastic material and the film stream of plastic material.

The wind sifter and the ballistic separator may be combined in the separator unit or used separately.

The pre-sorting arrangement may further comprise a bag opener configured to open bags in the waste stream to separate the plastic material from the bags.

The bag opener typically open bags in which parts of the waste stream may be present. The bag opener typically open bags by ripping the bags open. By opening such bags the plastic material in the bags may be exposed and possible to sort into the particulate stream of plastic material and the film stream of plastic material.

The pre-sorting arrangement may further comprise a first magnet arrangement configured to attract ferrous metal material of the waste stream, thereby sorting out ferrous metal from the waste stream.

The ferrous metal is valuable in the recycling process, by sorting out the metals the profit of the system may be further increased. Sorting the ferrous metal out from the waste stream may result in a decrease of material downstream in the waste stream thereby further decreasing the amount of plastic material that may end up in the wrong fraction.

The pre-sorting arrangement may further comprise an eddy current separator configured to separate non-ferrous metal material of the waste stream, thereby sorting out non-ferrous metal comprising material from the waste stream.

The non-ferrous metal material is valuable in the recycling process, by sorting out the metal the profit of the system may be further increased. Sorting the non-ferrous metal out from the waste stream may result in a decrease of material downstream in the waste stream thereby further decreasing the amount of plastic material may end up in the wrong fraction.

The pre-sorting arrangement may further comprise a drum screen configured to receive the waste stream and to separate material from the waste stream, that has a maximum cross-sectional extension larger than 300 mm, preferably larger than 320 mm, into a shredder stream.

The drum screen may thus provide a separation of the oversized material. The oversized material may otherwise clog a conveyor belt used for conveying the material to be sorted in the later steps. By separating the oversized material the flow of the waste stream may be stable which results in a decreased need of personnel for unclogging the conveyor belt.

The pre-sorting arrangement may further comprise a shredder configured to receive the shredder stream from the drum screen, and to shred material of the shredder stream to decrease the maximum cross-sectional extension of the material such that the maximum cross-sectional extension is smaller than 320 mm, preferably smaller than 300 mm, and to eject the shredded material into the waste stream from the bag opener.

The shredder may thus decrease the size of the material such that it may not be oversized, thereby further increasing the recycled material.

The pre-sorting arrangement may further comprise a waste screen configured to receive the waste stream from the drum screen and to separate material with maximum cross-sectional extension smaller than 40 mm into a screen residue stream.

Material in the waste stream with a cross-sectional extension smaller than 40 mm comprises mostly of non-valuable materials that may not be recycled. By separating this material from the waste stream sand and other smaller particles may be diverted.

The pre-sorting arrangement may further comprise a second magnet arrangement configured to attract ferrous material of the screen residue stream, thereby sorting out ferrous metal comprising material from the screen residue stream.

The second magnet arrangement may provide a means for sorting out ferrous metal from the screen residue stream.

According to a second aspect there is provided a system for purifying of a stream of a film plastic material fraction sorted out by a system according to the first aspect, the system comprising; a first purifying classification and sorting arrangement,
wherein the first purifying classification and sorting arrangement comprising a first purifying classification and sorting station configured to receive the stream of the film plastic material fraction, the first purifying classification and sorting station comprising a NIR spectroscopy system configured to discriminate the type of film plastic of the film plastic material fraction from other types of film plastic materials in the film stream of plastic material, and an ejection unit configured to divert the other types of film plastic from the stream of the film plastic material fraction into a purifying residue stream, thereby purifying the stream of the film plastic material fraction, wherein the first purifying classification and sorting arrangement further comprising a second purifying classification and sorting station configured to receive the stream of the film plastic material fraction from the first purifying classification and sorting station, the second purifying classification and sorting station comprising a NIR spectroscopy system configured to discriminate the type of film plastic from other types of film plastics in the stream of the film plastic material fraction and an ejection unit configured to divert the other types of film plastic from the stream of the film plastic material fraction into a purifying residue stream, thereby further purifying the stream of the film plastic material fraction.

In general, features of this aspect provide similar advantages as discussed above in relation to the previous aspect of the invention. Consequently, said advantages will not be repeated in order to avoid undue repetition.

By diverting the other types of material even higher purification grade may be reached for the film plastic material fraction. With a higher purification level the film plastic material may be reused. The purifying classification and sorting arrangement may be of the same type as the classification and sorting arrangement.

The first purifying classification and sorting arrangement may further comprise a cleaning purifying classification and sorting station configured to receive the purifying residue stream, the first cleaning purifying classification and sorting station comprising a NIR spectroscopy system configured to discriminate the type of film plastic of the purifying residue stream from other types of film plastic materials in the purifying residue stream and an ejection unit configured to divert the type of film plastic from the purifying residue stream into a purifying recovery stream, wherein the first purifying classification and sorting arrangement further comprising a second cleaning purifying classification and sorting station configured to receive the purifying residue stream from the first cleaning purifying classification and sorting station, the second cleaning purifying classification and sorting station comprising a NIR spectroscopy system configured to discriminate the type of film plastic from other types of film plastics in the purifying residue stream and an ejection unit configured to divert the type of film plastic from the purifying residue stream into a purifying recovery stream, wherein the purifying recovery stream is re-joined with the stream of the film plastic material fraction.

The system may further comprise a purifying pre-sorting arrangement configured to sort out material from the stream of the plastic material fraction before the stream of plastic material fraction reaches the first purifying classification and sorting arrangement, wherein the purifying pre-sorting arrangement comprising a purifying shredder configured to receive the stream of the plastic material fraction and to shred material of the stream of the plastic material fraction to decrease a maximum cross-sectional extension of the material such that it is smaller than 250 mm and more preferably smaller than 200 mm.

The purifying pre-sorting arrangement may further comprise a first purifying magnet arrangement configured to attract ferrous metal material of the stream of the film plastic material fraction, thereby sorting out ferrous metal comprising material from the stream of the film plastic material fraction.

The purifying pre-sorting arrangement may further comprise a purifying eddy current separator configured to separate non-ferrous metal material of the stream of the film plastic material fraction, thereby sorting out non-ferrous metal comprising material from the stream of the film plastic material fraction.

The purifying pre-sorting arrangement may further comprise a purifying drum screen configured to receive the stream of the plastic material fraction from the purifying shredder and to separate material from the stream of the plastic material fraction, that has a maximum cross-sectional extension larger than 250 mm, preferably larger than 200 mm, into the stream of the film plastic material fraction streaming into the purifying pre shredder.

The purifying pre-sorting arrangement may further comprise a purifying waste screen configured to receive the stream of the film plastic material fraction and to separate material with a maximum cross-sectional extension smaller than 25 mm into a purifying screen residue stream.

The system may further comprise an agglomeration arrangement configured to receive the stream of the film plastic material fraction from the first purifying and classification and sorting arrangement and to increase the bulk density of the film plastic material fraction.

By increasing the bulk density the stored material may be more compact. An advantage of this is the decreased need of storage capacity for the plant and the increased quantity that may be transported in one transport.

The agglomeration arrangement may comprise a shredder station configured to shred the film plastic material fraction into smaller pieces, and a friction station configured to bond the film plastic material fraction together by heating them through friction.

Each NIR spectroscopy system of said classification and sorting stations may be configured to acquire a spectrum of plastic material originating from the waste stream, and wherein each NIR spectroscopy system is configured to discriminate a plastic material from other plastic material based on the acquired spectrum.

According to a third aspect a method for sorting out different types of material from a waste, stream is provided. The method comprises, separating plastic material of the waste stream into a particulate stream of plastic material and a film stream of plastic material based on a combination of size, shape and density such that particulate plastic material is predominantly separated into the particulate stream of plastic material while plastic film material is predominantly separated into the film stream of plastic material, discriminating a first type of particulate plastic from other types of particulate plastics in the particulate stream of plastic material using a near infrared spectroscopy system, diverting the first type of particulate plastic from the particulate stream of plastic material into a first particulate plastic material fraction, thereby sorting out material of the first type of particulate plastic from the particulate stream of plastic material, discriminating a second type of particulate plastic from other types of particulate plastics in the particulate stream of plastic material using a near infrared spectroscopy system, diverting the second type of particulate plastic from the particulate stream of plastic material into a second particulate plastic material fraction, thereby sorting out material of the second type of particulate plastic from the particulate stream of plastic material, discriminating a first type of film plastic from other types of film plastics in the film stream of plastic material using a near infrared spectroscopy system, diverting the first type of film plastic from the film stream of plastic material into a first film plastic material fraction, thereby sorting out material of the first type of film plastic from the film stream of plastic material, discriminating a second type of film plastic from other types of film plastics in the film stream of plastic material using a near infrared spectroscopy system, and diverting the second type of film plastic from the film stream of plastic material into a second film plastic material fraction, thereby sorting out material of the second type of film plastic from the film stream of plastic material.

In general, features of this aspect provide similar advantages as discussed above in relation to the previous aspects of the invention. Consequently, said advantages will not be repeated in order to avoid undue repetition.

A further scope of applicability of the present invention will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular component parts of the device described as such device may vary. It is also to be understood that the terminology used herein is for purpose of describing particular variants only and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements.

### BRIEF DESCRIPTION OF THE DRAWINGS

The aspects of the present inventive concept, including its particular features and advantages, will be readily understood from the following detailed description and the accompanying drawings. The figures are provided to illustrate the general structures of the present inventive concept. Like reference numerals refer to like elements throughout.

FIG. 1 is a flow chart over a system for sorting out different types of material from a municipal solid waste, MSW, stream.

FIG. 2 is a flow chart over a system for sorting out different types of material from a municipal solid waste, MSW, stream with further stations in the system as compared to the system of FIG. 1.

FIG. 3 is a flow chart over a system for purifying a stream of a film plastic material fraction.

FIG. 4 is a flow chart over a system for purifying a stream of a film plastic material fraction, with further stations in the system as compared to the system of FIG. 3.

FIG. 5 is a perspective schematic view of a classification and sorting station.

FIG. 6 is a flow chart illustrating the different steps in a method for sorting out different types of material from a municipal solid waste, MSW, stream.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

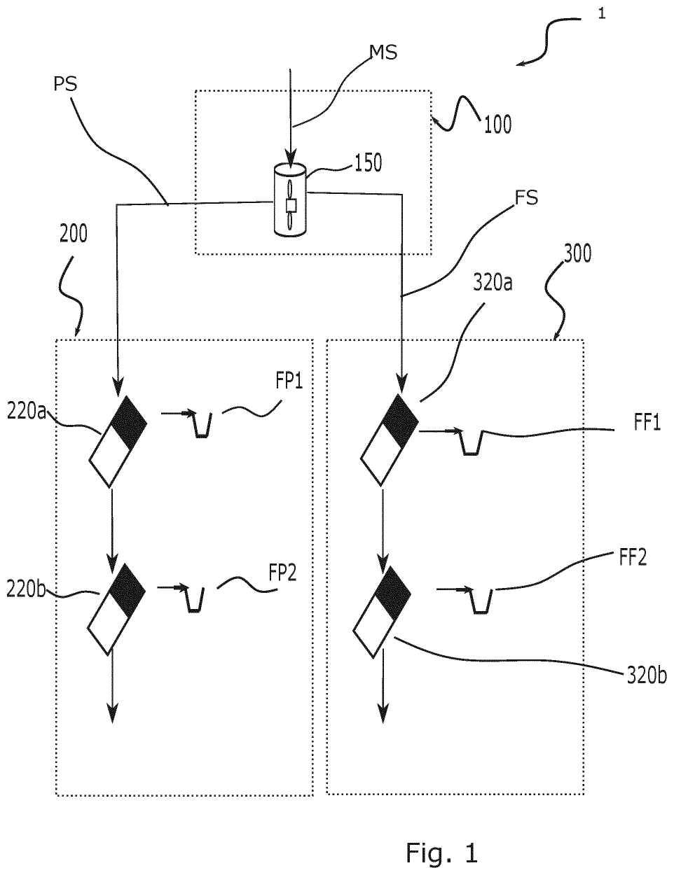

FIG. 1 illustrates a flow chart of a system 1 for sorting out different types of material from a municipal solid water, MSW, stream MS. The system comprises a pre-sorting arrangement 100, a first classification and sorting arrangement 200, and a second classification and sorting arrangement 300. The pre-sorting arrangement 100 comprises a separator unit 150. The pre-sorting arrangement 100 of the system 1 performs a first sorting of the plastic material into a particulate stream of plastic material PS and a film stream of plastic material FS. The sorting is based on the size, shape and density of the plastic material.

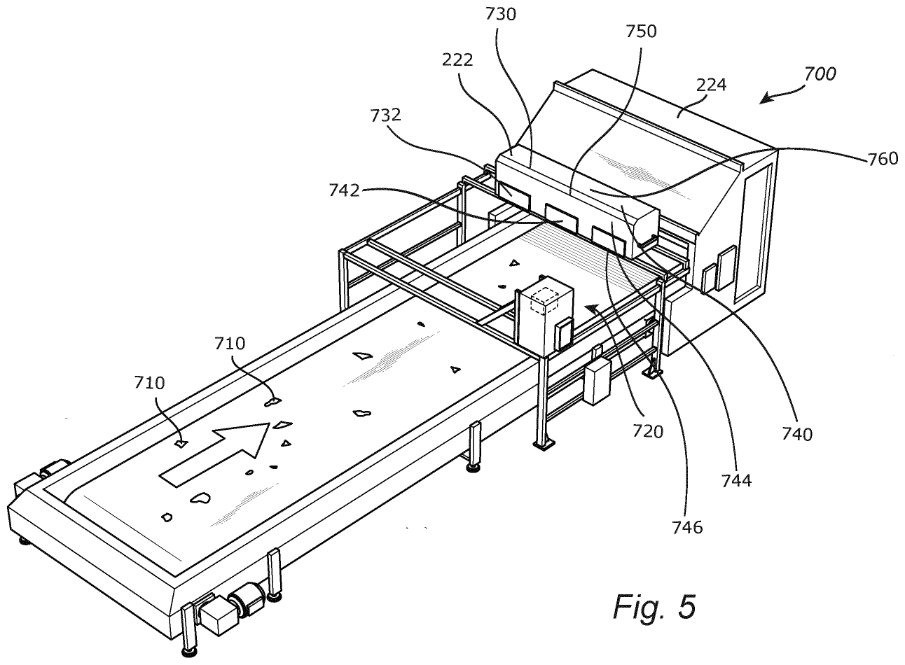

The film plastics are plastic which are generally thin. The particulate plastic is generally more rigid. The particulate plastic is generally thicker than the film plastic. The particulate plastic material is predominantly separated into the particulate stream of plastic material PS while plastic film material is predominantly separated into the film stream of plastic material FM. By separating the film plastic and the particulate plastic into two different streams the sorting process in the upcoming stages of the system are typically significantly improved. The pre-sorting arrangement 100 may use different kind of sorting techniques to advantage, as long as the plastic is separated into two different streams. In FIG. 1 the first classification and sorting arrangement 200 comprises, a first particulate classification and sorting station 220a, shown in greater detail in FIG. 5, configured to receive the particulate stream of plastic material PS from the pre-sorting arrangement 100.

The first particulate classification and sorting station 220a comprising a near infrared, NIR, spectroscopy system 222, as illustrated in FIG. 5, configured to discriminate a first type of particulate plastic from other types of particulate plastics in the particulate stream of plastic material PS, and an ejection unit 224, as illustrated in FIG. 5, configured to divert the first type of particulate plastic from the particulate stream of plastic material PS into a first particulate plastic material fraction FP1, thereby sorting out material of the first type of particulate plastic from the particulate stream of plastic material. The NIR spectroscopy systems 222 will be further described in connection to FIG. 5.

The first classification and sorting arrangement 200 further comprises, a second particulate classification and sorting station 220b configured to receive the particulate stream of plastic PS material from the first particulate classification and sorting station 220a. The second particulate classification and sorting station 220b comprising a near infrared, NIR, spectroscopy system 222 configured to discriminate a second type of particulate plastic from other types of particulate plastics in the particulate stream of plastic material PS received by the second particulate classification and sorting station 220b from the first particulate classification and sorting station 220a.

The second particulate classification and sorting station 220b comprises an ejection unit 224 configured to divert the second type of particulate plastic from the particulate stream of plastic material PS into a second particulate plastic material fraction FP2, thereby sorting out material of the second type of particulate plastic from the particulate stream of plastic material received by the second particulate classification and sorting station 220b.

The second classification and sorting arrangement 300 comprises, a first film classification and sorting station 320a configured to receive the film stream of plastic material FS from the pre-sorting arrangement 100. The first film classification and sorting station 320a comprising a near infrared, NIR, spectroscopy system 222 configured to discriminate a first type of film plastic from other types of film plastics in the film stream of plastic material FS, and an ejection unit 224 configured to divert the first type of film plastic from the film stream of plastic material FS into a first film plastic material fraction FF1. Thereby sorting out material of the first type of film plastic from the film stream of plastic material FS.

The second classification and sorting arrangement 300 further comprises a second film classification and sorting station 320b configured to receive the film stream of plastic material FS from the first film classification and sorting station 320a. The second film classification and sorting station comprises a near infrared, NIR, spectroscopy system 222 configured to discriminate a second type of film plastic from other types of film plastics in the film stream of plastic material FS received by the second film classification and sorting station 320b from the first film classification and sorting station 320a, and an ejection unit 224 configured to divert the second type of film plastic from the film stream of plastic material FS into a second film plastic material fraction FF2. Thereby sorting out material of the second type of film plastic from the film stream of plastic material FS received by the second film classification and sorting station 320b.

Hence owing from the separation performed by the pre-sorting arrangement 100, the two classification and sorting arrangements 200, 300, i.e. the first classification and sorting arrangement 200, and a second classification and sorting arrangement 300, need to handle one stream of plastic each which reduces the risk that the classification and sorting stations misses any part or type of the plastic fraction which it is assigned to discriminate. The particulate classification and sorting stations 220a, 220b and the film classification and sorting stations 320a, 320b may be of the same type as the classification and sorting station 700 described below in connection to FIG. 5. They may be provided with different settings and may also be provided with an optional combination of hardware.

The overall thought of the system 1 is to separate the MSW stream MS into streams with a more sorted material. This enables the two classification and sorting arrangements 200, 300 to focus on one kind of material which enhances the purity of the sorted fractions. The classification and sorting stations 220a, 220b, 320a, 320b provide the possibility to provide settings to the NIR spectroscopy system 222 which discriminate plastic that should be sorted out. By providing settings to the NIR spectroscopy system 222 the system is able to discriminate selected plastic material and sort it into a selective fraction. The actual sorting is performed by ejection units 224 configured to divert plastic based on the discrimination conducted by the NIR spectroscopy systems 222. The ejection units 224 is informed by the NIR spectroscopy systems 222 which plastic pieces that should be diverted. Then the ejection unit 224 typically divert the plastic pieces with air jets that blows the selected plastic pieces onto one conveyor belt and the other plastic pieces will end on another conveyor belt. Alternatively, or additionally, some kind of mechanical sorting or sorting with water jets may be used to advantage. The ejection unit 224 may divert the selected plastic pieces and the other plastic pieces onto different conveyor belts, which transports the different streams of waste material.

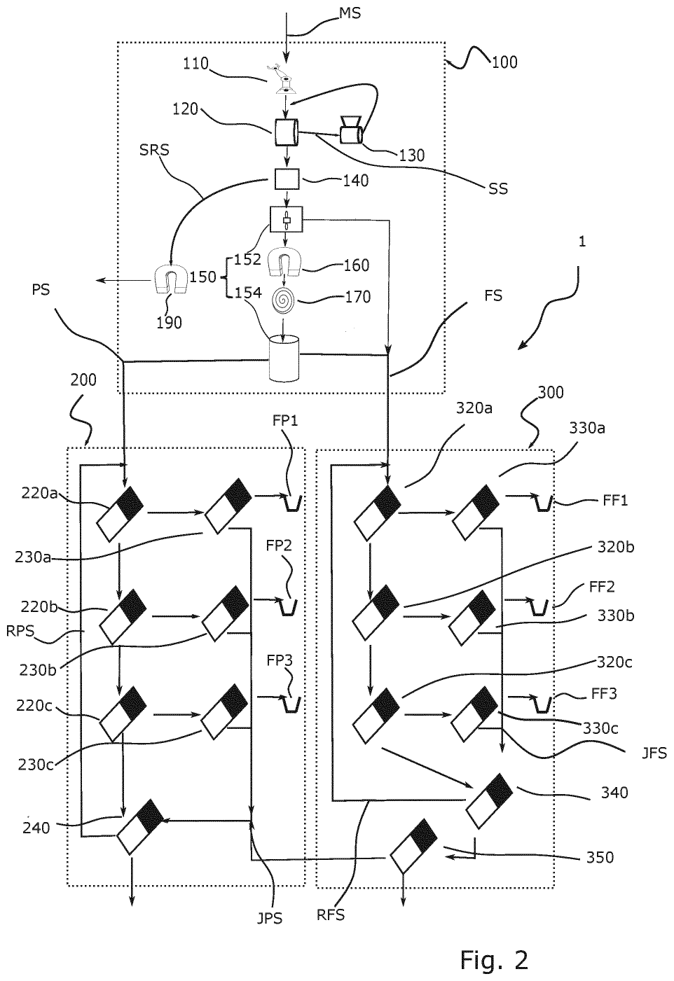

Turning to FIG. 2 an example of the system 1 for sorting out different types of material from a MSW stream MS with further stations as compared to the system 1 of FIG. 1 is disclosed as a flow chart. The stations that already has been described in connection to FIG. 1 forms part of the system 1 in FIG. 2 as well and will not be further described in this section. It should be stressed that the stations in system 1 in FIG. 1 are sufficient to reach a synergy effect when sorting the municipal solid waste, MSW, stream MS. In FIG. 2 there are examples of which kind of stations that may further be part of the system 1. The stations may alone form part of the system 1 in FIG. 1 or together with other stations. The stations are illustrated together to facilitate the understanding of the description. The different stations described below may be used alone or in any combination depending on the requirement of the plant in which the system 1 is operating.

The pre-sorting arrangement 100 may comprise any combination of the following stations, a bag opener 110, a drum screen 120, a shredder 130, a waste screen 140, a wind sifter 152, a first magnet arrangement 160, an eddy current arrangement 170, a ballistic separator 154 or/and a second magnet arrangement 190. In the following a system 1 that comprises all of the stations will be described. Each station may alone be a part of the system 1 in FIG. 1 or in combination with other stations.

In FIG. 2 the bag opener 110 is configured to open bags in the MSW stream MS to separate the plastic material from the bags as a first sorting step for the MSW stream MS. The bag opener 110 typically open bags in which parts of the MSW stream MS may be present. The bag opener 110 typically open bags by ripping the bags open. By opening such bags the plastic material in the bags may be exposed and possible to sort into the particulate stream of plastic material and the film stream of plastic material. Any type of suitable bag opener 110 may be used to advantage.

To avoid that too large material end up in the two plastic streams FS, PS a drum screen 120 is provided. The drum screen 120 is configured to receive the MSW stream MS and to separate material from the MSW stream MS, that has a maximum cross-sectional extension larger than 300 mm, preferably larger than 320 mm, into a shredder stream SS. The drum screen 120 may thus provide a separation of the oversized material. The oversized material may otherwise clog a conveyor belt used for conveying the material to be sorted in the later steps. Any type of suitable drum screen 120 may be used to advantage in the system 1.

To handle the oversized material the shredder 130 is provided. The shredder 130 is configured to receive the shredder stream SS from the drum screen 120, and to shred material of the shredder stream to decrease the maximum cross-sectional extension of the material such that the maximum cross-sectional extension is smaller than 320 mm, preferably smaller than 300 mm, and to eject the shredded material into the MSW stream MS from the bag opener 110. It is to be noted that the size of the allowed cross-sectional extension may be varied in different systems. The shredder 130 may thus decrease the size of the material such that it may not be oversized. By decreasing the size of the material, the material can be recirculated into the drum screen 120 to be able to move forward in the system 1. Any type of suitable shredder 130 may be used to advantage in the system 1.

The waste screen 140 is configured to receive the MSW stream MS from the drum screen 120 and to separate material with maximum cross-sectional extension smaller than 40 mm into a screen residue stream SRS. Material in the MSW stream MS with a cross-sectional extension smaller than 40 mm comprises mostly of non-valuable materials that may typically not be recycled. By separating this material from the MSW stream MS sand and other smaller particles may be diverted. Any type of suitable waste screen 140 may be used to advantage in the system 1.

The screen residue stream SRS with the material with a cross-sectional extension smaller than 40 mm is directed into a second magnet arrangement 190 configured to attract ferrous material of the screen residue stream, thereby sorting out ferrous metal comprising material from the screen residue stream. The second magnet arrangement 190 provides a mean for sorting out ferrous metal from the screen residue stream. Thus, valuable metals may be sorted out from the screen residue stream SRS before they are considered as a rest fraction, going for waste. Any type of suitable magnet arrangement 190 may be used to advantage in the system 1.

The separator unit 150 of the system 1 of FIG. 2 is provided with a wind sifter 152. The wind sifter 152 is configured to separate the MSW stream MS into the particulate stream of plastic material PS and the film stream of plastic material FS. The wind sifter 152 operates by removing the film plastic material from the MSW stream MS into a film stream of plastic material FS. Any type of suitable wind sifter 152 may be used to advantage in the system 1.

The first magnet arrangement 160 configured to attract ferrous metal material of the MSW stream MS, thereby sorting out ferrous metal from the MSW stream MS. The ferrous metal is valuable in the recycling process, by sorting out the metals the profit of the system may be further increased. Sorting the ferrous metal out from the MSW stream MS may result in a decrease of material downstream in the MSW stream MS thereby further decreasing the amount of plastic material that may end up in the wrong fraction. Any type of suitable magnet arrangement 160 may be used to advantage in the system 1.

The eddy current separator 170 is configured to separate non-ferrous metal material of the MSW stream MS, thereby sorting out non-ferrous metal comprising material from the MSW stream MS. The non-ferrous metal material is valuable in the recycling process, by sorting out the metal the profit of the system 1 may be further increased. Sorting the non-ferrous metal out from the MSW stream MS may result in a decrease of material downstream in the MSW stream MS thereby further decreasing the amount of plastic material may end up in the wrong fraction. Any type of suitable eddy current arrangement 170 may be used to advantage in the system 1.

The separator unit 150 of the pre-sorting arrangement 100 further comprises a ballistic separator 154 configured to separate the MSW stream MS into the particulate stream of plastic material PS and the film stream of plastic material FS. Any type of suitable ballistic separator 154 may be used to advantage in the system 1.

The only function of the pre-sorting arrangement 100 that is required in the system 1 is the separation into the particulate stream of plastic material PS and the film stream of plastic material FS. The other steps conducted by the other stations provides beneficial improvements to the system 1 and further increases the positive effect of the recycling levels, but they are not required as such.

Turning to the first classification and sorting arrangement 200. The first classification and sorting arrangement 200 comprises the stations as described in connection with FIG. 1. The different stations described below may be used alone or in any combination depending on the requirement of the plant where the system 1 is operating in. The first classification and sorting arrangement 200 in FIG. 2 further comprises a further particulate classification and sorting station 220c configured to receive the particulate stream of plastic material PS from the second particulate classification and sorting station 220b, the further particulate classification and sorting station 220c may comprise a near infrared, NIR, spectroscopy system 222 configured to discriminate a further type of particulate plastic from other types of particulate plastics in the particulate stream of plastic material PS received by the further particulate classification and sorting station 220c from the second particulate classification and sorting station 220b, and an ejection unit 224 configured to divert the further type of particulate plastic from the particulate stream of plastic material PS into a further particulate plastic material fraction FP3, thereby sorting out material of the further type of particulate plastic from the particulate stream of plastic material PS received by the further particulate classification and sorting station 220c.

The system may include one or more further particulate classification and sorting stations 220c. The number of further particulate classification and sorting stations 220c are typically determined by the number of particulate plastic fractions that are of interest for recycling in the particulate stream of plastic material PS.

Such further particulate classification and sorting station 220c typically discriminate a further type of particulate plastic from other types of particulate plastics in the particulate stream of plastic material PS received by the further particulate classification and sorting station 220c from the second particulate classification and sorting station 220b. As an example each particulate plastic material fraction may be one of PET originating from bottles, PET originating from trays, Polypropylene, Polyethylene, Polystyrene, Expanded Polystyrene, Polyurethane, Polyvinyl chloride, Polycarbonate, Polymethyl acrylate and Polyamide. If the system 1 needs to separate each of the mentioned particulate plastic materials into a particulate plastic material fraction there may be needed in total twelve particulate classification and sorting stations 220. However, there may be more kind of plastic material that may need to be recycled and thus more than twelve particulate classification and sorting stations 220 in the system 1. In some cases one classification and sorting station may handle more than one kind of plastic material.

The first classification and sorting arrangement 200 further comprises, a cleaning particulate classification and sorting station 230a-230c, for one or more particulate plastic material fractions FP1-FP3. Each cleaning particulate classification and sorting station 230a-230c is configured to receive a respective particulate plastic material fraction FP1-FP3 from a respective particulate classification and sorting station 220a-220c. Each cleaning particulate classification and sorting station 230a-230c may comprise a NIR spectroscopy system 222 configured to discriminate the type of particulate plastic of the particulate plastic material fraction from other types of particulate plastics in the received particulate plastic material fraction, and an ejection unit 224 configured to divert the other types of particulate plastic from the particulate material fraction into a joint residue particulate stream JPS such that the particulate plastic material fraction is further cleaned from other types of particulate plastics.

Each cleaning particulate classification and sorting station 230a-230c may discriminate materials with different spectra than the particulate plastic material fraction FP1-FP3 such that any material that may have ended up in the wrong fraction may be diverted into the joint residue particulate stream JPS. The joint residue particulate stream JPS is thus typically a collection stream of material that ended up in the wrong fraction. In the system 1 of FIG. 2 there is one cleaning particulate classification and sorting station 230a-230c situated downstream of each particulate classification and sorting station 220a-220c. The cleaning particulate classification and sorting station 230a-230c may therefore handle the particulate plastic material fraction FP1-FP3 from the particulate classification and sorting station 220a-220c upstream. In other systems the cleaning particulate classification and sorting station 230a-230c may be used for cleaning more than one fraction. In such case, the cleaning particulate classification and sorting station 230a-230c use different settings for the spectroscopy system on different longitudinal sides of a conveyor belt of the particulate classification and sorting station 220a-220c, i.e. as described above.

When the plastic material is sorted out to different fractions in the particulate classification and sorting stations 220a-220c there may be a stacking of the plastic material on a conveyor belt used to convey the plastic material being sorted. If the particulate classification and sorting stations 220a-220c are not able to determinate all of the plastic material some of the plastic material may not be diverted correctly or may not be diverted at all to its respective fraction. In this case the plastic material will be diverted by the cleaning particulate classification and sorting station 230a-230c into the joint residue particulate stream JPS. To be able to recycle this material as well, the first classification and sorting arrangement 200 further comprise a recovery particulate classification and sorting station 240 configured to receive the particulate stream of plastic material from the second particulate classification and sorting station 220b, or if present the further particulate classification and sorting station 220c.

The recovery particulate classification and sorting station 240 comprises a NIR spectroscopy system 222 configured to discriminate particulate plastic from other types of materials in the particulate stream of plastic material, and an ejection unit 224 configured to divert the particulate plastic from the particulate stream of plastic material into a recovery particulate stream of plastic material RPS, wherein the recovery particulate stream of plastic material RPS is re-joined with the particulate stream of plastic material PS from the pre-sorting arrangement. Hence, the recovery particulate classification and sorting station 240 provides a second opportunity for the plastic material to be sorted. Such recirculation of plastic material may result in even higher recycling levels of plastic. The recovery particulate classification and sorting station 240 is further configured to receive the joint residue particulate stream JPS and to discriminate particulate plastic from other types of materials in the joint residue particulate stream JPS. The ejection unit 224 of the recovery particulate classification and sorting station 240 may be further configured to divert the particulate plastic from the joint residue particulate stream JPS of plastic material into the recovery particulate stream RPS of plastic material.

Turning to the second classification and sorting arrangement 300 of the system 1 in FIG. 2. The second classification and sorting arrangement 300 comprises the stations as described in connection with FIG. 1. FIG. 2 is an overview of a possible combination of stations. The different stations described below may be used alone or in any combination depending on the requirement of the plant where the system 1 is operating in.

The second classification and sorting arrangement 300 further comprises a further film classification and sorting station 320c configured to receive the film stream of plastic material FS from the second film classification and sorting station 320b, the further film classification and sorting station 320c comprises a near infrared, NIR, spectroscopy system 222 configured to discriminate a further type of film plastic from other types of film plastics in the film stream of plastic material FS received by the further film classification and sorting station 320c from the second film classification and sorting station 320b, and an ejection unit 224 configured to divert the further type of film plastic from the film stream of plastic material FS into a further film plastic material fraction FF3, thereby sorting out material of the further type of film plastic from the film stream of plastic material FS received by the further 5 film classification and sorting station 320c. The system may include one or more further film classification and sorting stations 320c. The number of further film classification and sorting stations 320c are typically determined by the number of film plastic fractions that are of interest for recycling in the film stream of plastic material FS. Such further film classification and sorting station 320c typically discriminate a further type of film plastic from other types of film plastics in the film stream of plastic material FS received by the further film classification and sorting station 220c from the second film classification and sorting station 220b. As an example each film plastic material fraction may be one of Polyolefin film, low density polyethylene and polypropylene film. If the plant needs to separate each of the mentioned film plastic materials into a film plastic material fraction there may be needed in total three film classification and sorting stations 320. However, there may be more kind of plastic material that may need to be recycled and thus more than three film classification and sorting stations 320 in the system 1.

The second classification and sorting arrangement 300 further comprises, a cleaning film classification and sorting station 330a-330c, for one or more film plastic material fractions FF1-FF3 Each cleaning film classification and sorting station 330a-330c is configured to receive a respective film plastic material fraction FF1-FF3 from a respective film classification and sorting station 320a-320c. Each cleaning film classification and sorting station 330a-330c may comprise a NIR spectroscopy system 222 configured to discriminate the type of film plastic of the film plastic material fraction from other types of film plastics in the received film plastic material fraction, and an ejection unit 224 configured to divert the other types of film plastic from the film material fraction into a joint residue film stream JFS such that the film plastic material fraction is further cleaned from other types of film plastics. The cleaning film classification and sorting station 330a-330c may discriminate materials with different spectra than the film plastic material fraction FF1-FF3 such that any material that may have ended up in the wrong fraction will be diverted into the joint residue film stream JFS. The joint residue film stream JFS is thus typically a collection stream of material that ended up in the wrong fraction. In the system 1 of FIG. 2 there are one cleaning film classification and sorting station 330a-330c situated downstream of each film classification and sorting station 320a-320c. The cleaning film classification and sorting station 330a-330c may therefore handle the film plastic material fraction FF1-FF3 from the film classification and sorting station 320a-320c upstream. In other systems the cleaning film classification and sorting station 330a-330c may be used for cleaning more than one fractions. In such case, the cleaning film classification and sorting station 330a-330c use different settings for the spectroscopy system on different longitudinal sides of a conveyor belt of the film classification and sorting station 320a-320c, i.e. as described above.

When the plastic material is sorted out to different fractions in the film classification and sorting stations 320a-320c there may be a stacking of the plastic material on a conveyor belt used to convey the plastic material being sorted. If the film classification and sorting stations 320a-320c are not able to determinate all of the plastic material some of the plastic material may not be diverted correctly or may not be diverted at all to its respective fraction. In this case the plastic material will be diverted by the cleaning film classification and sorting station 330a-330c into the joint residue film stream JFS. To be able to recycle this material as well, the second classification and sorting arrangement 300 further comprise a recovery film classification and sorting station 360 configured to receive the film stream of plastic material FS from the second film classification and sorting station 320b, or if present the further film classification and sorting station 320c. The recovery film classification and sorting station 340 comprises a NIR spectroscopy system 222 configured to discriminate film plastic from other types of materials in the film stream of plastic material FS, and an ejection unit 224 configured to divert the film plastic from the film stream of plastic material FS into a recovery film stream RFS of plastic material, wherein the recovery film stream RFS of plastic material is re-joined with the film stream of plastic material FS from the pre-sorting arrangement. Hence, the recovery film classification and sorting station 340 provides a second opportunity for the plastic material to be sorted. Such recirculation of plastic material may result in even higher recycling levels of plastic. The recovery film classification and sorting station 340 is further configured to receive the joint residue film stream JFS and to discriminate film plastic from other types of materials in the joint residue film stream JFS. The ejection unit 224 of the recovery film classification and sorting station 340 may be further configured to divert the film plastic from the joint residue film stream JFS of plastic material into the recovery film stream RFS of plastic material.

In the pre-sorting arrangement 100 the material is typically separated into the particulate stream of plastic material PS and the film stream of plastic material FS. During the pre-sorting there may be particulate material that end up in the film stream of plastic material FS. To recycle the particulate material in the film stream of plastic material FS the second classification and sorting arrangement 300 further comprises, a value particulate classification and sorting station 350 configured to receive the film stream of plastic material FS from the recovery film classification and sorting station 340, the value particulate classification and sorting station 350 may comprise a NIR spectroscopy system 222 configured to discriminate particulate plastic from other types of materials in the film stream of plastic material FS, and an ejection unit 224 configured to divert the particulate plastic from the film stream of plastic material FS into the recovery particulate stream of plastic material PS. The particulate classification and sorting stations 220a-220c, the film classification and sorting stations 320a-320c, the cleaning particulate classification and sorting stations 230a-230c, the cleaning film classification and sorting stations 330a-330c, the recovery particulate classification and sorting station 240, the recovery film classification and sorting station 340 and the value particulate classification and sorting station 350 may be of the same type as the classification and sorting station 700 described below in connection to FIG. 5. They may be provided with different settings and may also be provided with an optional combination of hardware.

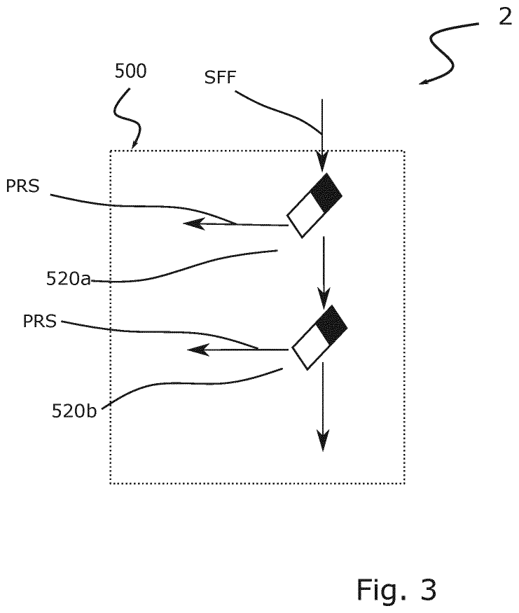

Turning to FIG. 3, here is schematically depicted a system 2 for purifying a stream of a film plastic material fraction sorted out by a system 1 as described in conjunction to FIGS. 1 and 2. FIG. 3 illustrates a flow chart of the purifying system 2 The system 2 comprises a first purifying classification and sorting arrangement 500. Some film plastic fraction may need further purification to e.g. be profitable, the purifying system 2 may provide such purification when needed. The first purifying classification and sorting arrangement 500 comprises a first purifying classification and sorting station 520a configured to receive the stream of the film plastic material fraction SFF. The first purifying classification and sorting station 520a comprises a NIR spectroscopy system 222 configured to discriminate the type of film plastic intended to be present in the film plastic material fraction SFF from other types of film plastic materials in the stream of the film plastic material fraction SFF, and an ejection unit 224 configured to divert other types of film plastic from the stream of the film plastic material fraction SFF into a purifying residue stream PRS. In this way the stream of the film plastic material fraction SFF may be purified such that the type of film intended to be present in the film plastic material fraction SFF becomes less contaminated with other types of plastic.

The first purifying classification and sorting arrangement 500 further comprises a second purifying classification and sorting station 520b configured to receive the stream of the film plastic material fraction SFF from the first purifying classification and sorting station 520a. The second purifying classification and sorting station 520 comprises a NIR spectroscopy system 222 configured to discriminate the type of film plastic intended to be present in the film plastic material fraction SFF from other types of film plastics in the stream of the film plastic material fraction SFF, and an ejection unit 224 configured to divert other types of film plastic from the stream of the film plastic material fraction SFF into a purifying residue stream PRS. In this way the stream of the film plastic material fraction SFF may be purified such that the type of film intended to be present in the film plastic material fraction SFF becomes less contaminated with other types of plastic. Some film plastic material fractions may need further purifying too e.g. be profitable. By having a system 2 for purifying the film plastic material at the site of the system 1 more of the plastics may be recycled.

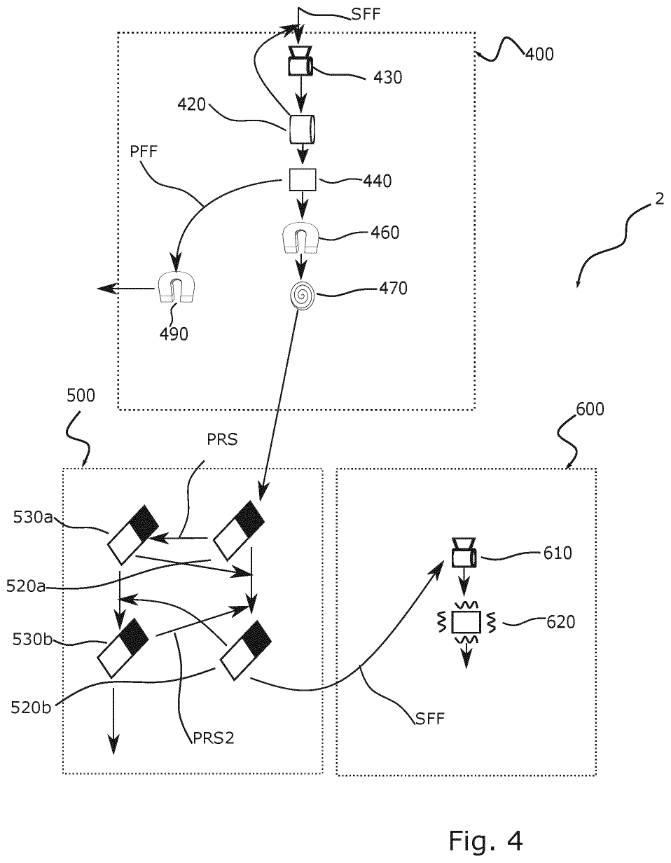

Turning to FIG. 4 an example of the system 2 for purifying a stream of a film plastic material fraction SFF sorted out by a system 1 as described in conjunction with FIGS. 1 and 2. The system 2 of FIG. 4 includes further stations as compared to the system 2 of FIG. 3. The stations that already has been described in connection to FIG. 3 forms part of the system 2 in FIG. 4 as well and will not be further described in this section. The system 2 is disclosed as a flow chart. It should be stressed that only the stations in system 2 in FIG. 3 are sufficient to reach the synergy effect when purifying a stream of the film plastic material fraction SFF. In FIG. 4 there are examples of which kind of stations that may further be part of the system 2. The stations are illustrated together to facilitate the understanding of the description. The different stations described below may be used alone or in any combination depending on the requirement of the plant where the system 2 is operating in.

In FIG. 4 the first purifying classification and sorting arrangement 500 also comprises a cleaning purifying classification and sorting station 530a configured to receive the purifying residue stream PRS. The first cleaning purifying classification and sorting station 530a comprises a NIR spectroscopy system 222 configured to discriminate the type of film plastic of the purifying residue stream PRS from other types of film plastic materials in the purifying residue stream PRS, and an ejection unit 224 configured to divert said type of film plastic from the purifying residue stream PRS into a purifying recovery stream PRS2.

The first purifying classification and sorting arrangement 500 further comprises a second cleaning purifying classification and sorting station 530b configured to receive the purifying residue stream PRS from the first cleaning purifying classification and sorting station 530a. The second cleaning purifying classification and sorting station 530b comprising a NIR spectroscopy system 222 configured to discriminate the type of film plastic from other types of film plastics in the purifying residue stream PRS, and an ejection unit 224 configured to divert said type of film plastic from the purifying residue stream PRS into a purifying recovery stream PRS2.

The purifying recovery stream PRS2 is then re-joined with the stream of the film plastic material fraction SFF. The diverted material from the purifying classification and sorting stations 520a, 520b are thus controlled an extra time by the cleaning purifying classification and sorting stations 530a, 530b. If the cleaning purifying classification and sorting stations 530a, 530b find any film plastic material that may be recycled it sends it back to the purifying classification and sorting stations 520a, 520b. This is an extra control function that increases the purity of the material and the recycling levels. Material that does not pass the control by the cleaning purifying classification and sorting stations 530a, 530b are considered as waste.

In order to enhance sorting of the film plastic material fraction a purifying pre-sorting arrangement 400 may be used to advantage as depicted in FIG. 4. In FIG. 4 the system 2 is provided with a purifying pre-sorting arrangement 400 configured to sort out material from the stream of the film plastic material fraction SFF before the stream of film plastic material fraction SFF reaches the first purifying classification and sorting arrangement 500.

The purifying pre-sorting arrangement 400 comprises a purifying shredder 430, a purifying drum screen 420, a purifying waste screen 440, a first magnet arrangement 460, an eddy current separator 470 and a second magnet arrangement 490.

The purifying shredder 430 is configured to receive the stream of the film plastic material fraction SFF and to shred material of the stream of the film plastic material fraction to decrease a maximum cross-sectional extension of the material such that it is smaller than 250 mm and more preferably smaller than 200 mm. Any type of suitable shredder may be used to advantage in the system 2.

The purifying drum screen 420 is configured to receive the stream of the film plastic material fraction SFF from the purifying shredder 430. The purifying drum screen 420 is configured to separate material from the stream of the film plastic material fraction SFF, that has a maximum cross-sectional extension larger than 250 mm, preferably larger than 200 mm, into the stream of the film plastic material fraction SFF streaming into the purifying pre shredder. To reduce the risk of oversized material reaching the purifying classification and sorting arrangement 500 the purifying drum screen 420 is used. Any type of suitable drum screen may be used to advantage in the system 2.

The purifying waste screen 440 is configured to receive the stream of the film plastic material fraction SFF and to separate material with a maximum cross-sectional extension smaller than 25 mm into a purifying screen residue stream. Material in the stream of the film plastic material fraction with a cross-sectional extension smaller than 25 mm comprises mostly of non-valuable materials that may not be recycled. By separating this material from the stream of film plastic material fraction SFF, sand and other smaller particles may be diverted. Any type of suitable waste screen may be used to advantage in the system 2.

The first purifying magnet arrangement 440 is configured to attract ferrous metal material of the stream of the film plastic material fraction SFF, thereby sorting out ferrous metal comprising material from the stream of the film plastic material fraction SFF. Any type of suitable magnet arrangement may be used to advantage in system 2.

The purifying eddy current separator 470 is configured to separate non-ferrous metal material of the stream of the film plastic material fraction SFF, thereby sorting out non-ferrous metal comprising material from the stream of the film plastic material fraction SFF. Any type of suitable eddy current separator may be used to advantage in system 2.

The second purifying magnet arrangement 490 is configured to attract ferrous metal material of the purifying screen residue stream PFF, thereby sorting out ferrous metal comprising material from the purifying screen residue stream PFF. Any type of suitable magnet arrangement may be used to advantage in system 2. The material not attracted by the second purifying magnet arrangement 490 are considered to be waste.

The system 2 in FIG. 4 further comprises an agglomeration arrangement 600. The agglomeration arrangement 600 is configured to receive the stream of the film plastic material fraction SFF from the first purifying and classification and sorting arrangement 500 and to increase the bulk density of the film plastic material fraction. The agglomeration arrangement 600 comprises a shredder station 610 configured to shred the film plastic material fraction into smaller pieces. The agglomeration arrangement 600 comprises a friction station 620 configured to bond the film plastic material fraction together by heating its components or parts through friction. By increasing the bulk density, the stored material may be made more compact. An advantage of this is the decreased need of storage capacity for the plant and the increased quantity that may be transported in one transport.

Turning to FIG. 5 a perspective schematic view of a classification and sorting station 700 is illustrated. The particulate classification and sorting stations 220a-220c, the film classification and sorting stations 320a-320c, the cleaning particulate classification and sorting stations 230a-230c, the cleaning film classification and sorting stations 330a-330c, the recovery particulate classification and sorting station 240, the recovery film classification and sorting station 340 and the value particulate classification and sorting station 350 may all be the same type as the classification and sorting station 700 that is described here. Each of said stations may have one or more of the features described below. However, in the following the station 700 is for reasons of simplicity described as a classification and sorting station 700.

The classification and sorting station 700 is fed with pieces of material 710. The pieces of material 700 is conveyed through a detection zone 720. However, the pieces of material 700 may be provided through the detection zone 720 by any suitable mean or manually without any technical means. A light source arrangement 730 and a NIR spectroscopy system 222 are provided. The spectroscopy system 222 is adapted to receive and analyse light 732, from the light source arrangement 730, which is reflected and/or scattered by the pieces of material 710 in the detection zone 720. Hence, the NIR spectroscopy system 222 typically acquires a spectrum of the pieces of material 710 from the stream of material that is conveyed through the detection zone 720. The NIR spectroscopy system 222 of the classification and sorting station 700 is configured to discriminate a plastic material from other plastic material based on the acquired spectrum. In other words, the NIR system 222 is typically set up such that a specific type of plastic material is discriminated form other types of plastic material owing from its spectrum.

The classification and sorting stations may further comprise a light spectroscopy system 760 configured to acquire a spectrum of plastic material originating from the stream of material that is conveyed through the detection zone 720. The ejection unit 224 of the classification and sorting station 700 may be further configured to divert said plastic material originating from the MSW stream based on the acquired spectrum thereby sorting the plastic material fraction based on its colour.

The light spectroscopy system 760 may through the acquired spectrum determine the different colours of the plastic material that is conveyed through the detection zone 720. An advantage of determining the colours of the plastic material is that it may be sorted into different fractions.

The classification and sorting station 700 may further comprise a laser triangulation system 740 configured to determine height information of material 710 that is conveyed through the detection zone 720. The ejection unit 224 of said at least one classification and sorting station may be further configured to divert said plastic material based on the determined height information.

The laser triangulation system 740 is typically configured to emit a line of laser light 742 towards the detection zone 720. The depicted laser triangulation system 740 includes a camera-based sensor arrangement 744 configured to receive and analyse light 746 which is reflected and/or scattered by the piece of material 710 in the detection zone 720. By means of the laser triangulation system 740 the classification and sorting station 700 may be able to detect plastic material that the NIR spectroscopy system 222 have difficulties to detect. One example of such plastic material is black plastic material. By detecting height differences on a conveyor belt used to convey the material being sorted, the classification and sorting station may combine such height information with the acquired information from the NIR spectroscopy system 222 to determine if there is any black plastic or plastic that is hard to detect on the conveyor belt. Accordingly, further plastic material may be recycled.

The classification and sorting station 700 may further comprise a camera 750 configured to acquire images of plastic material originating from the stream of material that is conveyed through the detection zone 720. The classification and sorting station 700 may comprise an artificial neural network in combination with the camera 750. Such artificial neural network may be configured to detect different characteristics of plastic material that is conveyed through the detection zone 720 based on images acquired by the camera 750. The ejection unit 224 of the classification and sorting station 700 may in this case be further configured to divert plastic material that is conveyed through the detection zone 720 based on the detected characteristics of plastic material. In other words, characteristics of plastic material may thus be determined by the artificial neural network from the, by the camera, acquired images. The characteristics may be a shape, a colour, features at the surface or anything in the visual appearance of the plastic material that may be determined and classified by the artificial neural network. The camera 750 may provide the possibility to further sort the material into different fractions. With the help of the artificial neural network it may be possible to sort plastic of the same material composition into different fractions depending on quality and origin.

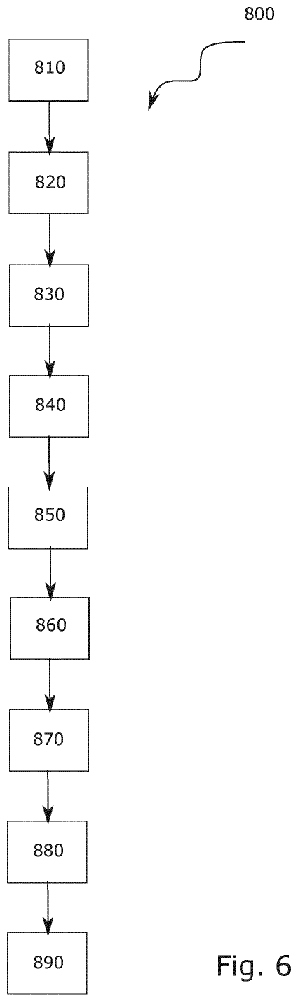

Now also referring to FIG. 6. A method 800 for sorting out different types of material from a municipal solid waste, MSW, will now be described.

The method 800 starts with separating 810 plastic material of the MSW stream MS into a particulate stream of plastic material PS and a film stream of plastic material FS based on a combination of size, shape and density such that particulate plastic material is predominantly separated into the particulate stream of plastic material PS while plastic film material is predominantly separated into the film stream of plastic material FS.

The method 800 proceeds with discriminating 820 a first type of particulate plastic from other types of particulate plastics in the particulate stream of plastic material PS using a NIR spectroscopy system 222.

The method 800 proceeds with diverting 830 the first type of particulate plastic from the particulate stream of plastic material PS into a first particulate plastic material fraction FP1, thereby sorting out material of the first type of particulate plastic from the particulate stream of plastic material PS.

The method 800 proceeds with discriminating 840 a second type of particulate plastic from other types of particulate plastics in the particulate stream of plastic material PS using a NIR spectroscopy system 222.

The method 800 proceeds with diverting 850 the second type of particulate plastic from the particulate stream of plastic material PS into a second particulate plastic material fraction FP2, thereby sorting out material of the second type of particulate plastic from the particulate stream of plastic material PS.

The method 800 proceeds with discriminating 860 a first type of film plastic from other types of film plastics in the film stream of plastic material FS using a NIR spectroscopy system 222.

The method 800 proceeds with diverting 870 the first type of film plastic from the film stream of plastic material into a first film plastic material fraction FF1, thereby sorting out material of the first type of film plastic from the film stream of plastic material FS.

The method 800 proceeds with discriminating 880 a second type of film plastic from other types of film plastics in the film stream of plastic material FS using a NIR spectroscopy system 222.

The method 800 proceeds with diverting 890 the second type of film plastic from the film stream of plastic material FS into a second film plastic material fraction FF2, thereby sorting out material of the second type of film plastic from the film stream of plastic material FS.

It is to be noted that the steps in the steps or acts of the above method 800 may be conducted in any suitable order and hence not just in the order given above. Further, one or more of the steps or acts may be conducted in parallel. It is also to be noted that the steps or acts may be conducted by different equipment, at different times and/or at different sites. In other words, as an example, the method may be performed in a distributed manner at a plurality sites where different steps or acts are conducted at different points in time. However, the method may to advantage be conducted in the sequence described above at a single site.

Additionally, variations to the disclosed variants can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain measures are recited in mutually different dependent claims does not indicate that a combination of these measured cannot be used to advantage.

1. A system for sorting out different types of material from a waste stream, the system comprising;
a pre-sorting arrangement,
a first classification and sorting arrangement, and
a second classification and sorting arrangement,
wherein the pre-sorting arrangement comprising, a separator unit configured to separate plastic materials from the waste stream-into a particulate stream of plastic material and a film stream of plastic material-based on a combination of size, shape and density such that particulate plastic material is predominantly separated into the particulate stream of plastic material while plastic film material is predominantly separated into the film stream of plastic material,
wherein the first classification and sorting arrangement comprising, a first particulate classification and sorting station configured to receive the particulate stream of plastic material from the pre-sorting arrangement, the first particulate classification and sorting station comprising a near infrared, NIR, spectroscopy system configured to discriminate a first type of particulate plastic from other types of particulate plastics in the particulate stream of plastic material, and an ejection unit configured to divert the first type of particulate plastic from the particulate stream of plastic material into a first particulate plastic material fraction, thereby sorting out material of the first type of particulate plastic from the particulate stream of plastic material,
wherein the first classification and sorting arrangement further comprising, a second particulate classification and sorting station configured to receive the particulate stream of plastic material from the first particulate classification and sorting station, the second particulate classification and sorting station comprising a near infrared, NIR, spectroscopy system configured to discriminate a second type of particulate plastic from other types of particulate plastics in the particulate stream of plastic material received by the second particulate classification and sorting station from the first particulate classification and sorting station, and an ejection unit configured to divert the second type of particulate plastic from the particulate stream of plastic material into a second particulate plastic material fraction, thereby sorting out material of the second type of particulate plastic from the particulate stream of plastic material received by the second particulate classification and sorting station,
wherein the second classification and sorting arrangement comprising, a first film classification and sorting station configured to receive the film stream of plastic material from the pre-sorting arrangement, the first film classification and sorting station comprising a near infrared, NIR, spectroscopy system configured to discriminate a first type of film plastic from other types of film plastics in the film stream of plastic material, and an ejection unit configured to divert the first type of film plastic from the film stream of plastic material into a first film plastic material fraction, thereby sorting out material of the first type of film plastic from the film stream of plastic material,
wherein the second classification and sorting arrangement further comprising a second film classification and sorting station configured to receive the film stream of plastic material from the first film classification and sorting station, the second film classification and sorting station-comprising a near infrared, NIR, spectroscopy system configured to discriminate a second type of film plastic from other types of film plastics in the film stream of plastic material received by the second film classification and sorting station from the first film classification and sorting station, and an ejection unit configured to divert the second type of film plastic from the film stream of plastic material into a second film plastic material fraction, thereby sorting out material of the second type of film plastic from the film stream of plastic material received by the second film classification and sorting station.

2. The system according to claim 1, wherein the first classification and sorting arrangement further comprising a further particulate classification and sorting station configured to receive the particulate stream of plastic material from the second particulate classification and sorting station, the further particulate classification and sorting station comprising a near infrared, NIR, spectroscopy system configured to discriminate a further type of particulate plastic from other types of particulate plastics in the particulate stream of plastic material received by the further particulate classification and sorting station from the second particulate classification and sorting station, and an ejection unit configured to divert the further type of particulate plastic from the particulate stream of plastic material into a further particulate plastic material fraction, thereby sorting out material of the further type of particulate plastic from the particulate stream of plastic material received by the further particulate classification and sorting station.

3. The system according to claim 1, wherein the first classification and sorting arrangement further comprising, one or more cleaning particulate classification and sorting station, for one or more particulate plastic material fractions, each cleaning particulate classification and sorting station being configured to receive a respective particulate plastic material fraction from a respective particulate classification and sorting station, each cleaning particulate classification and sorting station comprising a NIR spectroscopy system configured to discriminate the type of particulate plastic of the particulate plastic material fraction from other types of particulate plastics in the received particulate plastic material fraction, and an ejection unit configured to divert the other types of particulate plastic from the particulate material fraction into a joint residue particulate stream such that the particulate plastic material fraction is further cleaned from other types of particulate plastics.

4. The system according to claim 1, wherein each particulate plastic material fraction is one of PET originating from bottles, PET originating from trays, Polypropylene, Polyethylene, Polystyrene, Expanded Polystyrene, Polyurethane, Polyvinyl chloride, Polycarbonate, Polymethyl acrylate and Polyamide.

5. The system according to claim 1, wherein the first classification and sorting arrangement further comprising, a recovery particulate classification and sorting station configured to receive the particulate stream of plastic material from the second particulate classification and sorting station, or if present the further particulate classification and sorting station, the recovery particulate classification and sorting station comprising a NIR spectroscopy system configured to discriminate particulate plastic from other types of materials in the particulate stream of plastic material, and an ejection unit configured to divert the particulate plastic from the particulate stream of plastic material into a recovery particulate stream of plastic material,
wherein the recovery particulate stream of plastic material is re-joined with the particulate stream of plastic material from the pre-sorting arrangement.

6. The system according to claim 5, wherein the recovery particulate classification and sorting station (240) is further configured to receive the joint residue particulate stream and to discriminate particulate plastic from other types of materials in the joint residue particulate stream, and wherein the ejection unit is further configured to divert the particulate plastic from the joint residue particulate stream of plastic material into the recovery particulate stream of plastic material.

7. The system according to claim 1, wherein the second classification and sorting arrangement further comprising a further film classification and sorting station configured to receive the film stream of plastic material from the second film classification and sorting station, the further film classification and sorting station comprising a near infrared, NIR, spectroscopy system configured to discriminate a further type of film plastic from other types of film plastics in the film stream of plastic material received by the further film classification and sorting station from the second film classification and sorting station, and an ejection unit configured to divert the further type of film plastic from the film stream of plastic material into a further film plastic material fraction, thereby sorting out material of the further type of film plastic from the film stream of plastic material received by the further film classification and sorting station.

8. The system according to claim 1, wherein the second classification and sorting arrangement further comprising one or more cleaning film classification and sorting station, for one or more film plastic material fractions, each cleaning film classification and sorting station being configured to receive a respective film plastic material fraction from a respective film classification and sorting station, each cleaning film classification and sorting station comprising a near infrared, NIR, spectroscopy system configured to discriminate the type of film plastic of the film plastic material fraction from other types of film plastics in the received film plastic material fraction and an ejection unit configured to divert the other types of film plastic from the film plastic material fraction into a joint residue film stream such that the film plastic material fraction is further cleaned from other types of film plastics.

9. The system according to claim 1, wherein each film plastic material fraction is one of Polyolefin film, low density polyethylene and polypropylene film.

10. The system according to claim 1, wherein the second classification and sorting arrangement further comprising, a recovery film classification and sorting station configured to receive the film stream of plastic material from the second film classification and sorting station, or if present from the further film classification and sorting station, the recovery film classification and sorting station comprising a near infrared, NIR, spectroscopy system configured to discriminate film plastic from other types of materials in the film stream of plastic material and an ejection unit configured to divert the film plastic from the film stream of plastic material into a recovery film stream of plastic material,
wherein the recovery film stream of plastic material is re-joined with the film stream of plastic material from the pre-sorting arrangement.

11. The system according to claim 10, wherein the recovery film classification and sorting station is further configured to receive the joint residue film stream and to discriminate film plastic from other types of materials in the joint residue film stream, and wherein the ejection unit is further configured to divert the film plastic from the joint residue film stream of plastic material into the recovery film stream of plastic material.

12. The system according to claim 10, wherein the second classification and sorting arrangement further comprising, a value particulate classification and sorting station-configured to receive the film stream of plastic material from the recovery film classification and sorting station, the value particulate classification and sorting station comprising a NIR spectroscopy system configured to discriminate particulate plastic from other types of materials in the film stream of plastic material, and an ejection unit configured to divert the particulate plastic from the film stream of plastic material into the joint residue particulate stream of plastic material.

13. The system according to claim 1, wherein at least one of the classification and sorting stations further comprising a camera configured to acquire images of plastic material originating from the waste stream and an artificial neural network configured to detect different characteristics of plastic material and wherein the ejection unit of said at least one classification and sorting station is further configured to divert said plastic material originating from the waste stream based on the detected characteristics of plastic material.

14. The system according to claim 1, wherein at least one of the classification and sorting stations further comprising a light spectroscopy system configured to acquire a spectrum of plastic material originating from the waste stream, wherein the ejection unit of said at least one classification and sorting station is further configured to divert said plastic material originating from the waste stream based on the acquired spectrum thereby sorting the plastic material fraction based on colour.

15. The system according to claim 1, wherein at least one of the classification and sorting stations further comprising a laser triangulation system configured to determine height information of plastic material originating from the waste stream wherein the ejection unit of said at least one classification and sorting station is further configured to divert said plastic material originating from the waste stream based on the determined height information.

16. (canceled)

17. (canceled)

18. (canceled)

19. (canceled)

20. (canceled)

21. (canceled)

22. (canceled)

23. (canceled)

24. A system for purifying of a stream of a film plastic material fraction sorted out by a system according to claim 1, the system comprising;
a first purifying classification and sorting arrangement,
wherein the first purifying classification and sorting arrangement comprising a first purifying classification and sorting station configured to receive the stream of the film plastic material fraction, the first purifying classification and sorting station comprising a NIR spectroscopy system configured to discriminate the type of film plastic of the film plastic material fraction from other types of film plastic materials in the stream of the film plastic material fraction, and an ejection unit configured to divert the other types of film plastic from the stream of the film plastic material fraction into a purifying residue stream, thereby purifying the stream of the film plastic material fraction,
wherein the first purifying classification and sorting arrangement further comprising a second purifying classification and sorting station configured to receive the stream of the film plastic material fraction from the first purifying classification and sorting station, the second purifying classification and sorting station comprising a NIR spectroscopy system configured to discriminate the type of film plastic from other types of film plastics in the stream of the film plastic material fraction and an ejection unit configured to divert the other types of film plastic from the stream of the film plastic material fraction into a purifying residue stream, thereby further purifying the stream of the film plastic material fraction.

25. The system according to claim 24, wherein the first purifying classification and sorting arrangement further comprising a cleaning purifying classification and sorting station configured to receive the purifying residue stream, the first cleaning purifying classification and sorting station comprising a NIR spectroscopy system configured to discriminate the type of film plastic of the purifying residue stream from other types of film plastic materials in the purifying residue stream and an ejection unit configured to divert the type of film plastic from the purifying residue stream into a purifying recovery stream,
wherein the first purifying classification and sorting arrangement further comprising a second cleaning purifying classification and sorting station configured to receive the purifying residue stream from the first cleaning purifying classification and sorting station, the second cleaning purifying classification and sorting station comprising a NIR spectroscopy system configured to discriminate the type of film plastic from other types of film plastics in the purifying residue stream and an ejection unit configured to divert the type of film plastic from the purifying residue stream into a purifying recovery stream,
wherein the purifying recovery stream is re-joined with the stream of the film plastic material fraction.

26. (canceled)

27. (canceled)

28. (canceled)

29. (canceled)

30. (canceled)

31. The system according to claim 24 further comprising an agglomeration arrangement configured to receive the stream of the film plastic material fraction from the first purifying and classification and sorting arrangement (500) and to increase the bulk density of the film plastic material fraction.

32. The system according to claim 31, wherein the agglomeration arrangement comprising a shredder station configured to shred the film plastic material fraction into smaller pieces, and
a friction station configured to bond the film plastic material fraction together by heating them through friction.

33. (canceled)

34. A method for sorting out different types of material from a municipal solid waste, waste, stream, the method comprising,
separating plastic material of the MSW stream into a particulate stream of plastic material and a film stream of plastic material based on a combination of size, shape and density such that particulate plastic material is predominantly separated into the particulate stream of plastic material while plastic film material is predominantly separated into the film stream of plastic material,
discriminating a first type of particulate plastic from other types of particulate plastics in the particulate stream of plastic material using a near infrared spectroscopy system,
diverting the first type of particulate plastic from the particulate stream of plastic material into a first particulate plastic material fraction, thereby sorting out material of the first type of particulate plastic from the particulate stream of plastic material,
discriminating a second type of particulate plastic from other types of particulate plastics in the particulate stream of plastic material using a NIR spectroscopy system,
diverting the second type of particulate plastic from the particulate stream of plastic material into a second particulate plastic material fraction, thereby sorting out material of the second type of particulate plastic from the particulate stream of plastic material,
discriminating a first type of film plastic from other types of film plastics in the film stream of plastic material using a NIR spectroscopy system,
diverting the first type of film plastic from the film stream of plastic material into a first film plastic material fraction, thereby sorting out material of the first type of film plastic from the film stream of plastic material,
discriminating a second type of film plastic from other types of film plastics in the film stream of plastic material using a NIR spectroscopy system, and
diverting the second type of film plastic from the film stream of plastic material into a second film plastic material fraction, thereby sorting out material of the second type of film plastic from the film stream of plastic material.
